(19) United States
(12) Patent Application Publication
(10) Pub. No.: US 2003/0053370 A1
(43) Pub. Date: Mar. 20, 2003

(54) Stirring machine for laminated tube solder

(76) Inventor: Takehiko Murakami, Tokyo (JP)

Correspondence Address: COLEMAN SUDOL SAPONE, P.C., 714 Colorado Avenue, Bridgeport, CT, 06605-1601, US

(21) Appl. No.: 10/229,807

(22) Filed: Aug. 28, 2002

(30) Foreign Application Priority Data
Sep. 17, 2001 (JP) 2001-281272

(51) Int. Cl. B01F 9/02

(52) U.S. Cl. 366/217

(57) ABSTRACT

To solve a problem of a height at a time of stirring a laminated tube solder by a conventional apparatus, makes it easy to keep balance at a time of rotating, and improve a stirring efficiency, a pair of circular supporting plates (7, 7) are fixed to portions near both end portions of a rotation driving shaft (2) which is horizontally supported to a stand (1), the rotation driving shaft (2) is rotated by a drive motor (3), four rotary tubes (8, 8) with opening and closing lids are supported between a pair of circular supporting plates (7, 7), and the rotary tubes (8, 8) are revolved around the rotation driving shaft (2) in a vertical direction while being made rotate around their own axes respectively.

### BACKGROUND OF THE INVENTION

1. Field of the Invention

The present invention relates to a stirring machine for a laminated tube solder.

2. Conventional Art

In a screen printing machine, a solder is used as a printing agent, and, the solder is conventionally contained in a cup. Then, the solder charged in the cup by a maker is preserved in a refrigerator, and is stirred at a time of being used so as to be made soft from a solidified state.

Further, this stirring operation is executed by horizontally rotating the cup filled with the solder by the stirring machine. In this case, a height of the cup is about 10 cm. However, a laminated tube solder as shown in FIG. 8 becomes to be used recently. The laminated tube solder 100 is structured such that a solder 102 is charged into a laminated tube 101, and an adhesive tape 104 for sealing until being used is attached to a outlet 103.

In the case of the laminated tube solder mentioned above, a whole length L thereof is about twice a length of the conventional cup. Accordingly, this is too long to be stirred by the conventional stirring machine which horizontally rotates a vertically placed cup. Further, since a weight in a state of the solder being charged reaches 500 g, it is hard to keep balance in relation to a centrifugal force for horizontally rotating the laminate tube solder vertically placed.

### SUMMARY OF THE INVENTION

The present invention is made by taking the points mentioned above into consideration, and an object of the present invention is to provide a stirring machine for a laminated tube solder structured such as to make a rotary tube with an opening and closing lid which receives the laminated tube solder revolve in a vertical direction while making the rotary tube rotate on its own axis in a horizontally tilted state, thereby solving the problems mentioned above and further improving a stirring efficiency.

Then, in accordance with an aspect of the present invention, there is provided a stirring machine for a laminated tube solder comprising:

a rotation driving shaft horizontally supported to a stand, the rotation driving shaft being rotated by a drive motor fixed to the stand;

a pair of circular supporting plates which is fixed to portions near both end portions of the rotation driving shaft in an axial direction in parallel; and

a plurality of rotary tubes with opening and closing lids which are supported between the pair of circular supporting plates in such a manner as to symmetrically surround the rotation driving shaft,

in which the rotary tubes with the opening and closing lids respectively rotate around their own axes via a desired driving mechanism.

Further, in the structure mentioned above, in accordance with a further particular structure, there is provided a stirring machine for a laminated tube solder comprising:

a stand;

a rotation driving shaft which is horizontally supported to the stand;

a drive motor which is fixed to the stand;

pulleys which are fixed to a rotary shaft of the drive motor and an end portion of the rotation driving shaft protruding out from the stand respectively;

a belt wound between these pulleys;

a pair of circular supporting plates which are fixed to portions near both end portions of the rotation driving shaft in an axial direction in parallel;

a plurality of rotary tubes with opening and closing lids which are supported between the pair of circular supporting plates in such a manner as to symmetrically surround the rotation driving shaft, and have shaft portions in end portions in the side of the pulleys respectively protruded out from the circular supporting plate;

pulleys which are fixed to the shaft portions of the rotary tubes with the opening and closing lids protruding out from the circular supporting plate;

a belt which is wound between the pulleys;

pulleys which are fixed to the shaft portion of one rotary tube with the opening and closing lid among a plurality of rotary tubes with the opening and closing lids and to a portion of the rotation driving shaft in the inner side of the stand respectively; and

a belt which is wound between the pulleys.

### BRIEF DESCRIPTION OF THE DRAWINGS

FIG. 1 is a front view of the present invention with a partly cross sectional view;

FIG. 2 is a left side view of the present invention;

FIG. 3 is a right side view of the present invention;

FIG. 4 is a plan view of the present invention;

FIG. 5 is a front view of a state in which a rotary tube with an opening and closing lid is exploded;

FIG. 6 is a schematic view which describes an operation of the present invention;

FIG. 7 is a perspective view of an auxiliary tube; and

FIG. 8 is a schematic view of a laminated tube solder.

### DESCRIPTION OF THE PREFERRED EMBODIMENT

A description will be given of an embodiment in accordance with the present invention with reference to the accompanying drawings.

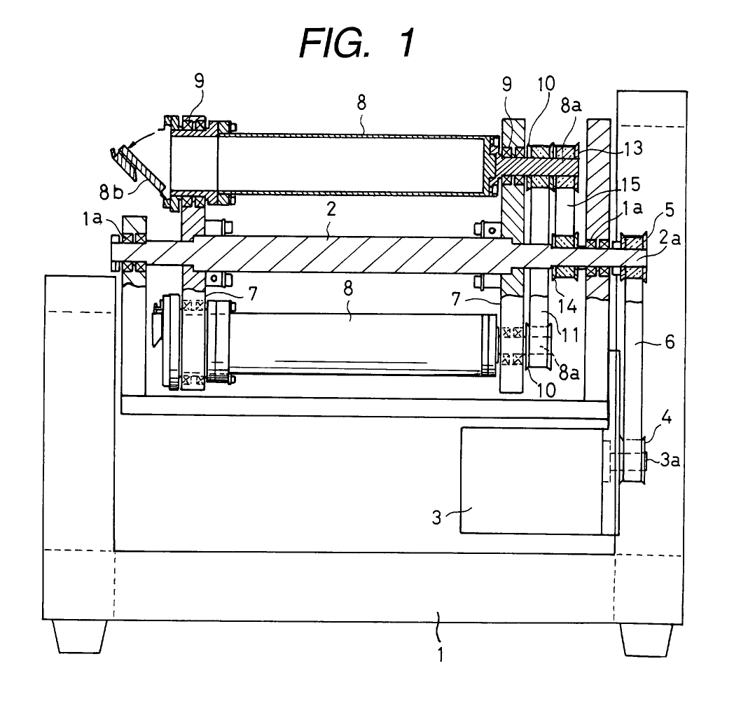

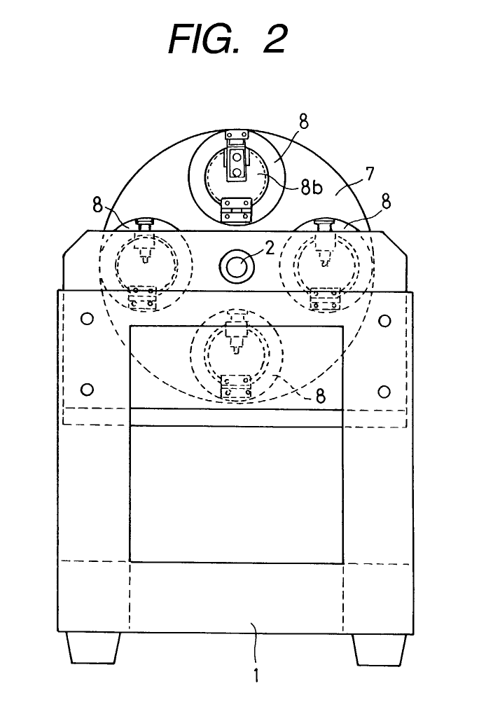

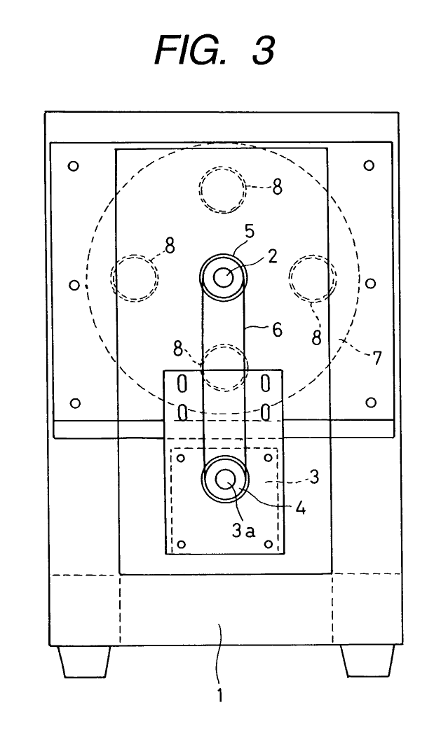

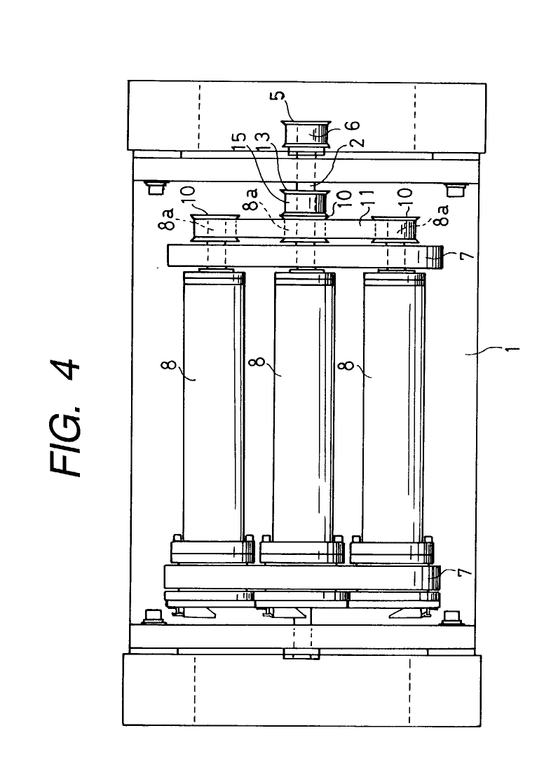

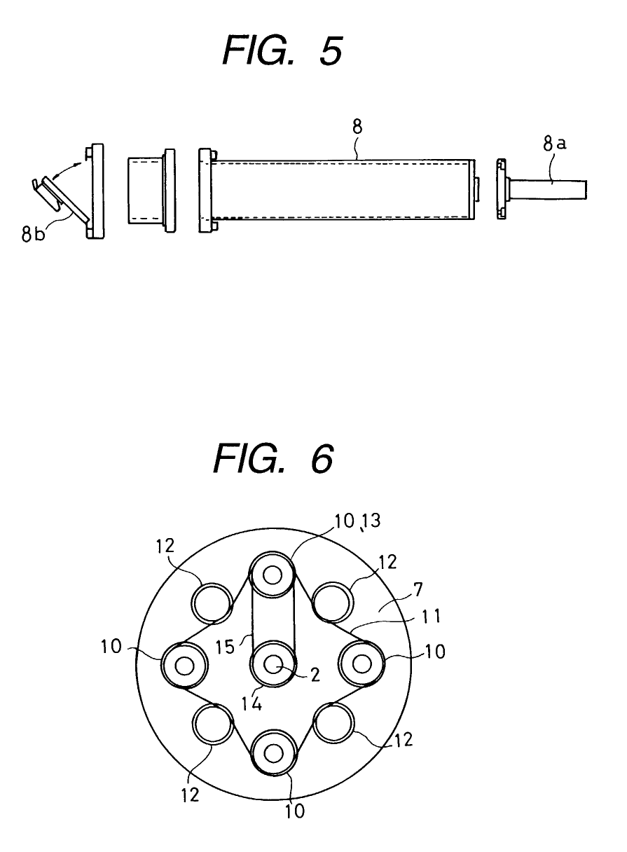

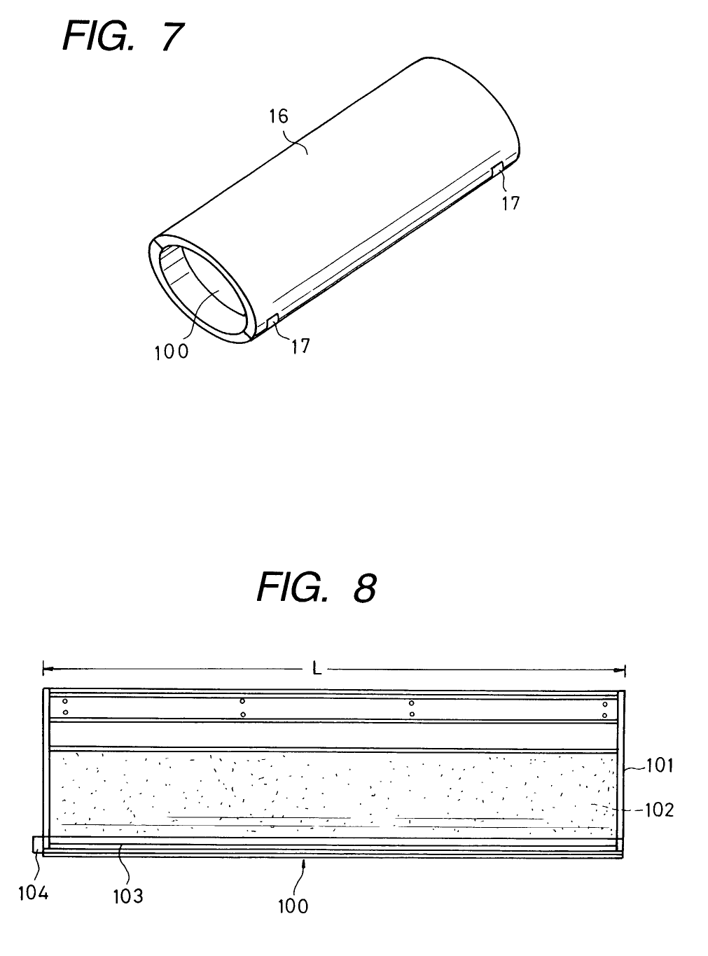

FIG. 1 is a front view with a partly cross sectional view, FIG. 2 is a left side view, FIG. 3 is a right side view, FIG. 4 is a plan view, FIG. 5 is a front view of a state in which a rotary tube with an opening and closing lid is exploded, FIG. 6 is a schematic view an operation, FIG. 7 is a perspective view of an auxiliary tube, and FIG. 8 is a schematic view of a laminated tube solder.

In the drawings, reference numeral 1 denotes a stand. In this case, in the drawings, a cover is omitted. Further, reference symbol la denotes a bearing for rotatably supporting a rotation driving shaft mentioned below. Reference numeral 2 denotes a rotation driving shaft which is horizontally supported to the stand 1. Further, the rotation driving shaft 2 is protruded out from the stand 1 at one end thereof. In this case, reference symbol 2a denotes a protruding portion.

Reference numeral 3 denotes a drive motor which is fixed to the stand 1. The drive motor 3 constitutes a rotation driving source for the rotation driving shaft 2. Reference numeral 4 denotes a pulley which is fixed to a rotary shaft 3a of the drive motor 3, reference numeral 5 denotes a pulley which is fixed to the end portion 2a of the rotation driving shaft 2 protruding out from the stand 1, and reference numeral 6 denotes a belt which is wound between the pulleys 4 and 5.

Reference numerals 7 and 7 denote a pair of circular supporting plates which are fixed to portions near both end portions of the rotation driving shaft 2 in an axial direction in parallel. Reference numerals 8 and 8 denote rotary tubes with opening and closing lids 8b which are supported between a pair of circular supporting plates 7 and 7 so as to symmetrically surround the rotation driving shaft 2 and have shaft portions 8a in end portions in the side of the pulleys 4 and 5 protruded out from the circular supporting plates 7 and 7. Further, in the present embodiment, the number of the rotary tubes 8 with the opening and closing lids is set to four, however, the number may be made larger than this, or may be reversely made smaller. Further, the rotary tubes 8 with the opening and closing lids are rotatably supported to a pair of circular supporting plates 7 and 7 via bearings 9, respectively.

Reference numerals 10 and 10 denote pulleys which are fixed to the shaft portions 8a protruding out from the circular supporting plate 7 in the rotary shafts 8 and 8 with the opening and closing lids respectively, and reference numeral 11 denotes a belt which is wound between the pulleys 10 and 10. Reference numerals 12 and 12 denote tension pulleys which are provided in the circular supporting plate 7.

Reference numeral 13 denotes a pulley which is fixed to the shaft portion of one rotary tube with the opening and closing lid among a plurality of rotary tubes 8 and 8 with the opening and closing lids, reference numeral 14 denotes a pulley which is fixed to an inner portion of the rotation driving shaft 2 in an inner side of the stand 1, and reference numeral 15 denotes a belt which is wound between the pulleys 13 and 14.

Reference numeral 16 denotes an auxiliary tube which is used at a time when the laminated tube solder is received within the rotary tube 8 with the opening and closing lid. Further, the auxiliary tube 16 is made of an expanded polystyrene or the like, and can be freely opened and closed via a hinge.

Next, a description will be given of an operation of the present invention.

The laminated tube solder is inserted to the auxiliary tube 16 and then is received within the rotary tube 8 with the opening and closing lid. When operating the drive motor 3 under this state, the rotation driving shaft 2 rotates via the pulleys 4 and 5 and the belt 6. Then, a pair of circular supporting plates 7 and 7 are accordingly rotated, and a plurality of (four) rotary tubes 8 and 8 with the opening and closing lids which are supported between the plates are rotated around the rotation driving shaft 2. Accordingly, the rotary tubes 8 and 8 with the opening and closing lids revolve around the rotation driving shaft 2 in a vertical direction. Further, the shaft portion of one rotary tube with the opening and closing lid among a plurality of rotary tubes 8 and 8 with the opening and closing lids is simultaneously rotated via the pulleys 13 and 14 and the belt 15. Then, all of the rotary tubes 8 and 8 with the opening and closing lids rotate around their own axes by the pulleys 10 and 10 which are fixed to the shaft portions 8a in all of the rotary tubes 8 and 8 with the opening and closing lids, and the belt 11 which is wound around the pulleys 10 and 10. Therefore, the laminated tube solder received within the four rotary tubes 8 and 8 with the opening and closing lids can be stirred.

Since the present invention has the structure and the operation as mentioned above, it is possible to revolve the rotary tubes with the opening and closing lids which receive the laminated tube solder around the rotation driving shaft in the vertical direction while making themselves rotate around their own axes in a state of being horizontally tilted. Accordingly, it is possible to solve the problem in view of the height, and it is easy to keep balance at a time of rotating. In addition, the stirring efficiency can be further improved.

What is claimed is:

1. A stirring machine for a laminated tube solder comprising:
a rotation driving shaft horizontally supported to a stand, said rotation driving shaft being rotated by a drive motor fixed to the stand;
a pair of circular supporting plates which is fixed to portions near both end portions of said rotation driving shaft in an axial direction in parallel; and
a plurality of rotary tubes with opening and closing lids which are supported between said pair of circular supporting plates in such a manner as to symmetrically surround said rotation driving shaft,
in which said rotary tubes with the opening and closing lids respectively rotate around their own axes via a desired driving mechanism.

2. A stirring machine for a laminated tube solder comprising:
a stand;
a rotation driving shaft which is horizontally supported to said stand;
a drive motor which is fixed to said stand;
pulleys which are fixed to a rotary shaft of said drive motor and an end portion of said rotation driving shaft protruding out from said stand respectively;
a belt wound between these pulleys;
a pair of circular supporting plates which are fixed to portions near both end portions of said rotation driving shaft in an axial direction in parallel;
a plurality of rotary tubes with opening and closing lids which are supported between said pair of circular supporting plates in such a manner as to symmetrically surround said rotation driving shaft, and have shaft portions in end portions in the side of said pulleys respectively protruded out from said circular supporting plate;
pulleys which are fixed to the shaft portions of said rotary tubes with the opening and closing lids protruding out from said circular supporting plate;
a belt which is wound between said pulleys;
pulleys which are fixed to the shaft portion of one rotary tube with the opening and closing lid among said plurality of rotary tubes with the opening and closing lids and to a portion of said rotation driving shaft in the inner side of said stand respectively; and
a belt which is wound between the pulleys.
